(19) United States
(12) Patent Application Publication
(10) Pub. No.: US 2024/0129941 A1
(43) Pub. Date: Apr. 18, 2024

(54) EFFICIENT CELL BASEBAND PROCESSING POOLING

(71) Applicant: Nokia Solutions and Networks Oy, Espoo (FI)

(72) Inventors: Vaibhav SINGH, Bangalore (IN); Prasanna MUDLAPPA, Bangalore (IN)

(21) Appl. No.: 18/546,891

(22) PCT Filed: Apr. 6, 2021
(86) PCT No.: PCT/EP2021/058869

§ 371 Date: Aug. 17, 2023

(30) Foreign Application Priority Data
Feb. 27, 2021 (IN) 202141008348

(51) Int. Cl. H04W 72/52; H04W 48/20; H04W 72/21; H04W 72/51; H04W 72/566

(52) U.S. Cl. CPC H04W 72/52; H04W 48/20; H04W 72/21; H04W 72/51; H04W 72/566

(57) ABSTRACT

There are provided measures for efficient cell baseband processing pooling. Such measures exemplarily comprise acquiring a predicted future computational load of baseband processing for each selected radio cell of a plurality of radio cells, and determining an allocation of each selected radio cell of said plurality of radio cells to anyone of a plurality of processing resource units based on said predicted future computational load of baseband processing for each selected radio cell of said plurality of radio cells and computation capabilities of each of said plurality of processing resource units.

### FIELD

Various example embodiments relate to efficient cell baseband processing pooling. More specifically, various example embodiments exemplarily relate to measures (including methods, apparatuses and computer program products) for realizing efficient cell baseband processing pooling.

### BACKGROUND

The present specification generally relates to baseband (BB) pooling. BB pooling refers to pooling of BB processing of cells over multi-core processors. Here, BB processing is layer-1 (L1) and layer-2 (L2) real-time (RT) processing in 4G/5G RAN. It is a time-critical or real-time processing and needs to be processed within strict deadlines. Particularly, BB processing can be considered as the network side processing related to radio functions.

Deploying radio coverage for cellular networks is a massive task and involves huge cost. As network operators need to deploy thousands of base stations, it is necessary that the BB compute resources be used most efficiently. BB pooling is an important enabler for efficient usage of multi-core processors (e.g. central processing units (CPU)).

To reduce the overall cost on processors, power usage, real-estate to house hardware, etc., there is a need for efficient pooling of processors (as an example of processing resource units) to support a higher number of cells by a smaller number of cores, i.e., ‘n’ cells on ‘k’ cores, where n>k. Various advancements like network function virtualization (NFV), virtualized infrastructure manager (VIM), and management and orchestration (MANO) are proving to be great enablers to achieve pooling.

Open radio access network (oRAN) alliance has been established to develop an architecture based on open application programming interfaces (API) that will allow radio resource management (RRM) algorithms and radio access network (RAN) optimization algorithms to be hosted on an open platform called xRAN controller or radio intelligent controller (RIC) so as to interact with and guide the behavior of the RAN.

In traditional 4G/5G BB deployments, there are dedicated hardware resources foreseen for each cell (i.e., 1-to-1 mapping of cells to cores). Hardware resources are planned/configured for peak capacity. When the cells are lightly loaded, the resources are under-utilized and hence proving cost-inefficient and huge cost on operational expenditure (OPEX) for network operators. There will be stringent regulations in future on power consumption, forcing operator and network infrastructure vendors to adapt innovative techniques to save on power.

One such technique is pooling the L1 and L2 processing (BB processing) of cells on a common pool of processors (cores). This approach helps to perform BB processing of more than one cell on the same core when cells have not reached their peak-load (or with forced limited capacity, e.g. by reducing the number of user equipments (UE) (as an example of a terminal) in time division (TD) or frequency division (FD) processing). Traditional approaches of pooling based on just the past and present load are not efficient (may be based on radio resource control (RRC) connected users or active users, but do not have knowledge of actual processing required), as they are reactive in nature. These approaches do not provide an efficient and pro-active resource allocation solution.

In the current gNB (baseband) deployment, the hardware resources are allocated or configured for full capacity. However, turning-off some hardware resources when the load on the cells is very less is foreseen.

Such approach bears at least the following drawbacks.

Namely, on the one hand, a decision to turn-on or turn-off the hardware resource is reactive in nature (like quick responses) and is not based on longer and robust inputs. Hence, a decision according to such approach is neither proactive nor efficient.

Further, on the other hand, when resources configured for one cell are under-utilized, these cannot be used by another cell because of the above-discussed 1-to-1 mapping of cells to cores.

Furthermore, the timescale at which the turn on/off decisions are mostly taken is coarse, for example minutes.

However, the load on the cells varies in space and time (spatially and temporarily).

FIG. 9 is a schematic diagram showing an exemplary downlink (DL) physical resource blocks (PRB) usage over time, and in particular illustrates the temporal variation of DL PRB usage for a cell every minute (for a week (x axis is in minutes)), which is proportional to computational load of the cell as well. This variation in load could be leveraged in that multiple cells (even across different location) might share a common core to use the underlying computation resources efficiently. Namely, each cell shows a variation as illustrated in FIG. 9, where the computational load of several cells (normally, at least not necessarily) does not correlate to each other. In order to combine and assign determined cells to one processing resource unit (e.g. core), the computational load of these cells has to be known in advance in order to meet the combined load with the compute potential of the respective processing resource unit (e.g. core).

Hence, the problem arises that techniques for enabling processing of a higher number of cells using a lower number of cores (i.e., ‘n’ cells on ‘k’ cores, where n>k) are needed to allow for an efficient utilization of pools of processing resource units (e.g. processor cores).

Hence, there is a need to provide for efficient cell baseband processing pooling.

### SUMMARY

Various example embodiments aim at addressing at least part of the above issues and/or problems and drawbacks.

Various aspects of example embodiments are set out in the appended claims.

According to an exemplary aspect, there is provided a method comprising acquiring a predicted future computational load of baseband processing for each selected radio cell of a plurality of radio cells, and determining an allocation of each selected radio cell of said plurality of radio cells to anyone of a plurality of processing resource units based on said predicted future computational load of baseband processing for each selected radio cell of said plurality of radio cells and computation capabilities of each of said plurality of processing resource units.

According to an exemplary aspect, there is provided a method comprising determining a policy for a baseband processing scheduling entity, and transmitting said policy towards said baseband processing scheduling entity, wherein said policy includes at least one of selection information indicative of selected radio cells of a plurality of radio cells, priority information indicative of a priority order of said selected radio cells of said plurality of radio cells, and information on computation capabilities of each of a plurality of processing resource units available for baseband processing scheduling by said baseband processing scheduling entity.

According to an exemplary aspect, there is provided a method comprising determining per-cell monitoring information for a selected radio cell of a plurality of radio cells, and transmitting said per-cell monitoring information towards a baseband processing scheduling entity, wherein said per-cell monitoring information includes at least one of a key performance indicator, a cell throughput, a number of radio resource control connected terminals, a number of active terminals, a number of carrier aggregation users, a number of multi-user multiple input multiple output users, a quality of service class identifier, a guaranteed bit rate, a maximum bit rate, a latency sensitivity of on-going applications, a type of service, a combined weight aggregated for each terminal over all digital radio bearers, a list of key features enabled on said respective cell, a current computational load per slot, a current physical resource blocks usage, a rank of terminals served by said respective cell, a modulation and coding scheme, and a physical uplink control channel utilization.

According to an exemplary aspect, there is provided an apparatus comprising acquiring circuitry configured to acquire a predicted future computational load of baseband processing for each selected radio cell of a plurality of radio cells, and determining circuitry configured to determine an allocation of each selected radio cell of said plurality of radio cells to anyone of a plurality of processing resource units based on said predicted future computational load of baseband processing for each selected radio cell of said plurality of radio cells and computation capabilities of each of said plurality of processing resource units.

According to an exemplary aspect, there is provided an apparatus comprising determining circuitry configured to determine a policy for a baseband processing scheduling entity, and transmitting circuitry configured to transmit said policy towards said baseband processing scheduling entity, wherein said policy includes at least one of selection information indicative of selected radio cells of a plurality of radio cells, priority information indicative of a priority order of said selected radio cells of said plurality of radio cells, and information on computation capabilities of each of a plurality of processing resource units available for baseband processing scheduling by said baseband processing scheduling entity.

According to an exemplary aspect, there is provided an apparatus comprising determining circuitry configured to determine per-cell monitoring information for a selected radio cell of a plurality of radio cells, and transmitting circuitry configured to transmit said per-cell monitoring information towards a baseband processing scheduling entity, wherein said per-cell monitoring information includes at least one of a key performance indicator, a cell throughput, a number of radio resource control connected terminals, a number of active terminals, a number of carrier aggregation users, a number of multi-user multiple input multiple output users, a quality of service class identifier, a guaranteed bit rate, a maximum bit rate, a latency sensitivity of on-going applications, a type of service, a combined weight aggregated for each terminal over all digital radio bearers, a list of key features enabled on said respective cell, a current computational load per slot, a current physical resource blocks usage, a rank of terminals served by said respective cell, a modulation and coding scheme, and a physical uplink control channel utilization.

According to an exemplary aspect, there is provided an apparatus comprising at least one processor, at least one memory including computer program code, and at least one interface configured for communication with at least another apparatus, the at least one processor, with the at least one memory and the computer program code, being configured to cause the apparatus to perform acquiring a predicted future computational load of baseband processing for each selected radio cell of a plurality of radio cells, and determining an allocation of each selected radio cell of said plurality of radio cells to anyone of a plurality of processing resource units based on said predicted future computational load of baseband processing for each selected radio cell of said plurality of radio cells and computation capabilities of each of said plurality of processing resource units.

According to an exemplary aspect, there is provided an apparatus comprising at least one processor, at least one memory including computer program code, and at least one interface configured for communication with at least another apparatus, the at least one processor, with the at least one memory and the computer program code, being configured to cause the apparatus to perform determining a policy for a baseband processing scheduling entity, and transmitting said policy towards said baseband processing scheduling entity, wherein said policy includes at least one of selection information indicative of selected radio cells of a plurality of radio cells, priority information indicative of a priority order of said selected radio cells of said plurality of radio cells, and information on computation capabilities of each of a plurality of processing resource units available for baseband processing scheduling by said baseband processing scheduling entity.

According to an exemplary aspect, there is provided an apparatus comprising at least one processor, at least one memory including computer program code, and at least one interface configured for communication with at least another apparatus, the at least one processor, with the at least one memory and the computer program code, being configured to cause the apparatus to perform determining per-cell monitoring information for a selected radio cell of a plurality of radio cells, and transmitting said per-cell monitoring information towards a baseband processing scheduling entity, wherein said per-cell monitoring information includes at least one of a key performance indicator, a cell throughput, a number of radio resource control connected terminals, a number of active terminals, a number of carrier aggregation users, a number of multi-user multiple input multiple output users, a quality of service class identifier, a guaranteed bit rate, a maximum bit rate, a latency sensitivity of on-going applications, a type of service, a combined weight aggregated for each terminal over all digital radio bearers, a list of key features enabled on said respective cell, a current computational load per slot, a current physical resource blocks usage, a rank of terminals served by said respective cell, a modulation and coding scheme, and a physical uplink control channel utilization.

According to an exemplary aspect, there is provided a computer program product comprising computer-executable computer program code which, when the program is run on a computer (e.g. a computer of an apparatus according to any one of the aforementioned apparatus-related exemplary aspects of the present disclosure), is configured to cause the computer to carry out the method according to any one of the aforementioned method-related exemplary aspects of the present disclosure.

Such computer program product may comprise (or be embodied) a (tangible) computer-readable (storage) medium or the like on which the computer-executable computer program code is stored, and/or the program may be directly loadable into an internal memory of the computer or a processor thereof.

Any one of the above aspects enables an efficient utilization of pools of processing resource units (e.g. processor cores) to thereby solve at least part of the problems and drawbacks identified in relation to the prior art.

By way of example embodiments, there is provided efficient cell baseband processing pooling. More specifically, by way of example embodiments, there are provided measures and mechanisms for realizing efficient cell baseband processing pooling.

Thus, improvement is achieved by methods, apparatuses and computer program products enabling/realizing efficient cell baseband processing pooling.

### BRIEF DESCRIPTION OF THE DRAWINGS

In the following, the present disclosure will be described in greater detail by way of non-limiting examples with reference to the accompanying drawings, in which FIG. 1 is a block diagram illustrating an apparatus according to example embodiments,

FIG. 2 is a block diagram illustrating an apparatus according to example embodiments,

FIG. 3 is a block diagram illustrating an apparatus according to example embodiments,

FIG. 4 is a block diagram illustrating an apparatus according to example embodiments,

FIG. 5 is a block diagram illustrating an apparatus according to example embodiments,

FIG. 6 is a schematic diagram of a procedure according to example embodiments,

FIG. 7 is a schematic diagram of a procedure according to example embodiments,

FIG. 8 is a schematic diagram of a procedure according to example embodiments,

FIG. 9 is a schematic diagram showing an exemplary downlink physical resource blocks usage over time,

FIG. 10 shows a schematic diagram of an example of a system environment with signaling variants according to example embodiments,

FIG. 11 illustrates an example of a prediction behavior of an apparatus according to example embodiments,

FIG. 12 illustrates examples of prediction measures of an apparatus according to example embodiments,

FIG. 13 illustrates an example of a prediction behavior of an apparatus according to example embodiments,

FIG. 14 illustrates an example of a neural network with example inputs and outputs according to example embodiments,

FIG. 15 is a schematic diagram of a procedure according to example embodiments, and

FIG. 16 is a block diagram alternatively illustrating apparatuses according to example embodiments.

### DETAILED DESCRIPTION

The present disclosure is described herein with reference to particular non-limiting examples and to what are presently considered to be conceivable embodiments. A person skilled in the art will appreciate that the disclosure is by no means limited to these examples, and may be more broadly applied.

It is to be noted that the following description of the present disclosure and its embodiments mainly refers to specifications being used as non-limiting examples for certain exemplary network configurations and deployments. Namely, the present disclosure and its embodiments are mainly described in relation to 3GPP specifications being used as non-limiting examples for certain exemplary network configurations and deployments. As such, the description of example embodiments given herein specifically refers to terminology which is directly related thereto. Such terminology is only used in the context of the presented non-limiting examples, and does naturally not limit the disclosure in any way. Rather, any other communication or communication related system deployment, etc. may also be utilized as long as compliant with the features described herein.

Hereinafter, various embodiments and implementations of the present disclosure and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

According to example embodiments, in general terms, there are provided measures and mechanisms for (enabling/realizing) efficient cell baseband processing pooling.

Example embodiments are outlined below in general terms.

As mentioned above, to reduce the overall cost on processors, power usage, real-estate to house hardware, etc., there is a need for efficient pooling of processing resource units to support processing a higher number of cells by a smaller number of processing resource units (e.g. processor cores), i.e., ‘n’ cells on ‘k’ processing resource units, where n>k. In the backdrop of these challenges and enablers, according to example embodiments, machine learning (ML) based methods and measures on how the cells and processors (as an example of processing resource units) can be pooled for efficient utilization are proposed.

Here, the advancements in ML techniques are utilized to accurately predict the amount of compute required (CPU cycles) to process the cells in the pool and accordingly use the right number of cores. In the following specification, terms as ‘compute required’, ‘load’, ‘ computation requirement’ etc. of a cell are to be understood as a ‘computational load’ of the cell resulting from satisfying the overall BB processing tasks of the cell. Examples of the ‘computational load’ of the cell may be a number of CPU cycles necessary for satisfying the overall BB processing tasks of the cell or a (proportionate) degree of (capacity) utilization of a CPU. In other words, predicting a computational load according to example embodiments may be implemented e.g. by predicting a number of CPU cycles or by predicting a (proportionate) degree of (capacity) utilization of a CPU according to example embodiments.

As a result of simulations (‘Monte-Carlo’ simulations) it has been revealed that a pooling might gain of up to 2.5 times under normal load conditions. This would mean that most of the time only half of the resources or cores would have to be used to process all the cells (e.g., n=36 cells processed by k=18 cores). Unused cores can be shut-down to save power or used for some other non-time-critical processing.

Having such possible savings in mind, according to example embodiments, approaches are provided with respect to how to estimate/predict the computational load (i.e., predict the proportionate compute required (CPU cycles)) on cells in the pool for BB processing in-advance to facilitate processing of a higher number of cells using a lower number of cores (i.e., ‘n’ cells on ‘k’ cores, where n>k), while taking into consideration the priority of different cells based on various aspects like QOS, latency etc.

Heretofore, according to example embodiments, ML based techniques are utilized to achieve the above objective while minimizing data and processor overhead required for training the ML model to obtain good performance.

According to example embodiments, the approaches as proposed are suitable to implement over a controller platform such as a radio intelligent controller as introduced above.

According to example embodiments, for efficient pooling, precise knowledge on an amount of compute required for each cell in the pool is obtained by prediction of the computational load at a future point in time considering various characteristics (like cell throughput, RRC connected UEs, active UEs, number of carrier aggregation (CA) users, number of multi-user multiple input multiple output (MU-MIMO) users, quality of service class identifiers (QCI), guaranteed bitrates (GBR)/maximum bitrates (MBR), latency sensitivity indication, type of service, list of key features enabled on the cell, current CPU cycles usage per-slot, current physical resource block (PRB) usage, rank of UEs, modulation coding scheme (MCS), etc.).

While above-discussed known approaches do not consider the service specific priority of each cell, it has been found out that consideration of such priorities which is critical to design an efficient resource allocation solution. Hence, according to example embodiments, the priority of different cells are taken into consideration based on various aspects like quality of service (QoS), latency, control channel usage, type of services etc.

Some of the services instantiated on the controller platform (i.e., RIC) according to example embodiments may be common programmable modules that can be invoked. That is, these modules may be considered as common building blocks in the operation of multiple cells. According to example embodiments, one such module is implemented, having ability for respective interactions with multiple cells/services.

In detail, according to example embodiments, a new programmable block (as an example of a network node or network entity) exemplarily called ‘Compute Predictor and Orchestrator’ (CPO) is provided, that may consist of the two sub-modules ‘Compute Predictor’ (CP) and ‘Compute Scheduler’ (CS).

According to example embodiments, the Compute Predictor (CP) estimates/predicts, using ML, the computational load, e.g. the amount of CPU cycles necessary to process each cell (for user-plane processing).

According to further example embodiments, the Compute Scheduler (CS) determines the optimum core allocation schedule to cells as per their compute needs, service priority, and available resources.

According to alternative example embodiments, where the load prediction (module) is already present on the Controller Platform, the CS module can communicate directly with the load prediction (module) to determine an optimum core allocation schedule for different cells. The interaction between the CPO and the RAN (and other services) may be facilitated by the Controller Platform (RIC).

According to example embodiments, the control period for CP and CS is preferably one system frame number (SFN) duration (10 ms). Alternatively, the control period may be of the order of 50 to 100 ms. The control period may be different from the provided examples. Further, the control period may differ between the CP and the CS. The control period may also be variable.

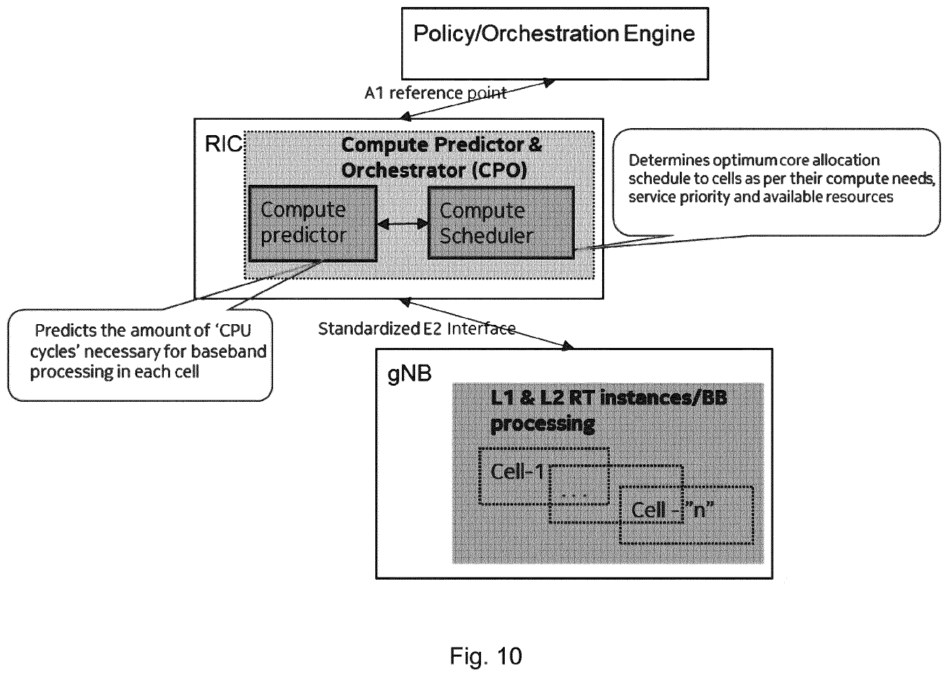

FIG. 10 shows a schematic diagram of an example of a system environment with signaling variants according to example embodiments, and in particular illustrates an overall architecture showing a policy engine, a RIC, as well as a gNB.

As is illustrated in FIG. 10, the CPO block according to example embodiments receives, via a policy application programming interface (API), an indication from a Policy Engine, describing policies to be applied to CPO, which may include
indications of which cells are to be handled by the CPO, and
biasing/priority factors for certain cells/carriers, amount of CPU and memory for cells.

According to example embodiments, additional attributes may be received by the CPO, including
a time interval over which the compute estimate/prediction should be valid,
a type of compute load estimate, at least one of—average, maximum, a given percentile for confidence interval,
a list of underlying loading factors—at least one of CPU utilization percent per core, memory utilization at a RAN node,
a function to apply to the loading factors—at least one of ‘weighted combination’, ‘min’ or ‘max’, ‘average’, etc.

As is further illustrated in FIG. 10, according to example embodiments, the CPO receives, via an API, different requested data that are monitored on each cell of interest and reported to the CPO for the machine learning CP module and the CS module, which may include
cell throughput and other key performance indicators,
RRC connected UEs,
active UEs, number of CA users, number of MU-MIMO users,
QCI, GBR/MBR, latency sensitivity indication, type of service—a combined weight aggregated for each UE over all DRBs,
list of key features enabled on the cell,
current CPU cycles usage per-slot,
current PRB usage,
rank of UEs, MCS, etc., and
physical uplink control channel (PUCCH) utilization, etc.

As is further implied in FIG. 10, according to example embodiments, the CP (sub) module makes use of ML techniques to estimate/predict computational load on each cell using received (per-Cell) inputs (“different requested data” as discussed above) and thus predicts e.g. the amount of CPU required for L2-RT processing (baseband processing) of each cell.

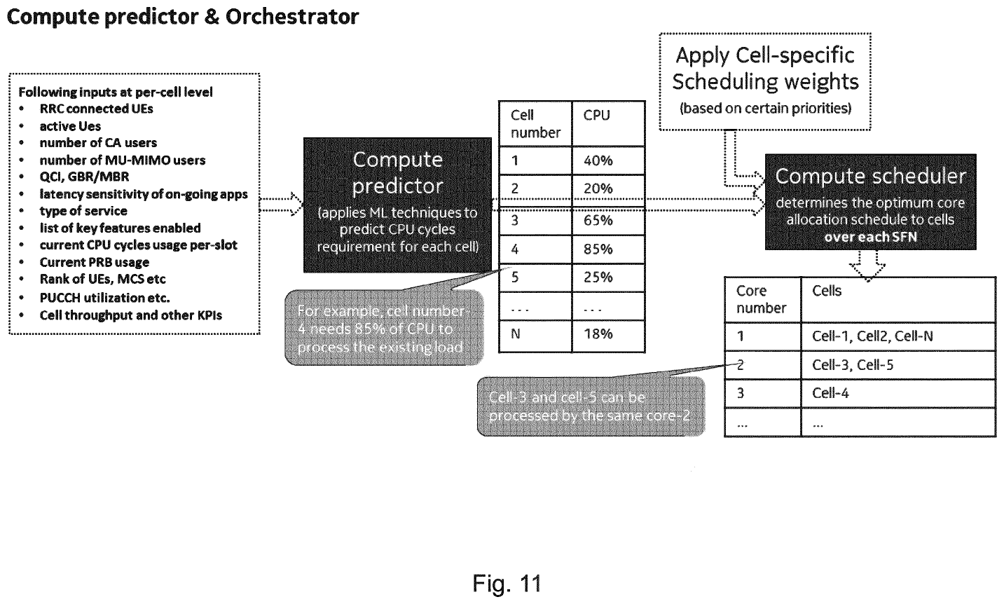

FIG. 11 illustrates an example of a prediction behavior of an apparatus according to example embodiments, and in particular illustrates an input to an ML model of the CP module and an output from the CS module. As can be seen in FIG. 11, the future CPU requirement (in %) is predicted based on the previous CPU usage reported and all other inputs reported to the CPO.

As is further implied in FIG. 10, according to example embodiments, the CS (sub) module runs an algorithm e.g.
to determine the ‘number of slots in each SFN’ a cell needs to be scheduled, taking into consideration the compute requirement, service priority, available resources and various other considerations, and
to map cells to cores in such a way that two or more cells are processed by a same core wherever possible (sequentially, within the slot duration, provided the load on the cells is low); for example, for FR1 time division duplex (TDD), slot duration is 500 μs, and if the processing requirement of two or three cells added-up is below 500 μs, then these two or three cells can be put onto the same core.

As is further implied in FIG. 10, according to example embodiments, the allocation from the CPO block is finally communicated to the resource allocator of the respective gNB/eNB through an API.

According to example embodiments, the CPO is implemented on the controller platform RIC. However, based on the latency constraint, according to example embodiments, the CPO (i.e. the CP module, the CS module) is instantiated in the gNB/eNB.

According to example embodiments, the ML model of the CP is periodically updated with incoming data, with the time period of update depending on the performance of the CP.

Example embodiments are described below in other words.

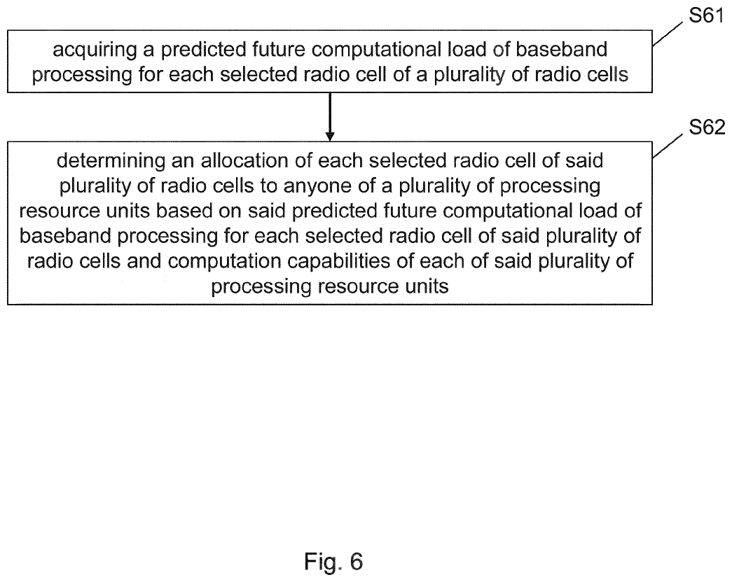

FIG. 1 is a block diagram illustrating an apparatus according to example embodiments. The apparatus may be a network node 10 such as a radio intelligent controller implementing a compute predictor and orchestrator, the apparatus comprising acquiring circuitry 11 and determining circuitry 12. The acquiring circuitry 11 acquires a predicted future computational load of baseband processing for each selected radio cell of a plurality of radio cells. The determining circuitry 12 determines an allocation of each selected radio cell of said plurality of radio cells to anyone of a plurality of processing resource units based on said predicted future computational load of baseband processing for each selected radio cell of said plurality of radio cells and computation capabilities of each of said plurality of processing resource units. FIG. 6 is a schematic diagram of a procedure according to example embodiments. The apparatus according to FIG. 1 may perform the method of FIG. 6 but is not limited to this method. The method of FIG. 6 may be performed by the apparatus of FIG. 1 but is not limited to being performed by this apparatus.

As shown in FIG. 6, a procedure according to example embodiments comprises an operation of acquiring (S61) a predicted future computational load of baseband processing for each selected radio cell of a plurality of radio cells, and an operation of determining (S62) an allocation of each selected radio cell of said plurality of radio cells to anyone of a plurality of processing resource units based on said predicted future computational load of baseband processing for each selected radio cell of said plurality of radio cells and computation capabilities of each of said plurality of processing resource units.

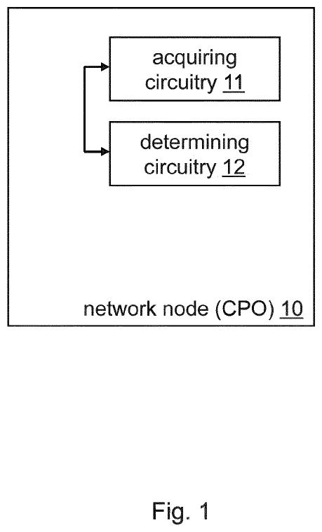

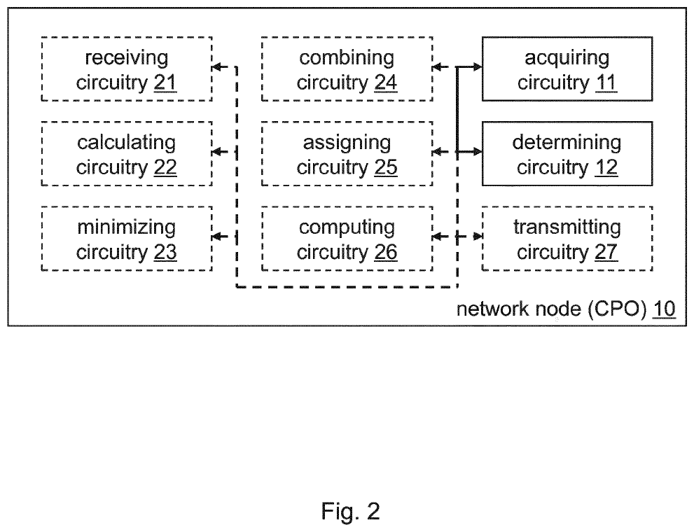

FIG. 2 is a block diagram illustrating an apparatus according to example embodiments. In particular, FIG. 2 illustrates a variation of the apparatus shown in FIG. 1. The apparatus according to FIG. 2 may thus further comprise receiving circuitry 21, calculating circuitry 22, minimizing circuitry 23, combining circuitry 24, assigning circuitry 25, computing circuitry 26, and/or transmitting circuitry 27.

In an embodiment at least some of the functionalities of the apparatus shown in FIG. 1 (or 2) may be shared between two physically separate devices forming one operational entity. Therefore, the apparatus may be seen to depict the operational entity comprising one or more physically separate devices for executing at least some of the described processes.

According to a variation of the procedure shown in FIG. 6, exemplary additional operations are given, which are inherently independent from each other as such. According to such variation, an exemplary method according to example embodiments may comprise an operation of receiving information on said computation capabilities of each of said plurality of processing resource units.

According to a variation of the procedure shown in FIG. 6, exemplary additional operations are given, which are inherently independent from each other as such. According to such variation, an exemplary method according to example embodiments may comprise an operation of receiving priority information indicative of a priority order of said selected radio cells of said plurality of radio cells. Here, said determining is based on said priority order of said selected radio cells of said plurality of radio cells.

According to a variation of the procedure shown in FIG. 6, exemplary additional operations are given, which are inherently independent from each other as such. According to such variation, said priority information includes per-cell priority information for each of said selected radio cells of said plurality of radio cells, and an exemplary method according to example embodiments may comprise an operation of calculating, for each respective of said selected radio cells of said plurality of radio cells, a respective cell priority based on said respective per-cell priority information for said respective of said selected radio cells of said plurality of radio cells.

According to further example embodiments, said per-cell priority information includes at least one of a quality of service class identifier, a guaranteed bit rate, a maximum bit rate, a latency sensitivity of on-going applications, a type of service, a rank of terminals served by said respective cell, a modulation and coding scheme, a physical uplink control channel utilization, and a number of past skipped slots.

According to a variation of the procedure shown in FIG. 6, exemplary additional operations are given, which are inherently independent from each other as such. According to such variation, an exemplary method according to example embodiments may comprise an operation of receiving selection information indicative of selection of said selected radio cells of said plurality of radio cells.

According to a variation of the procedure shown in FIG. 6, exemplary details of the determining operation (S62) are given, which are inherently independent from each other as such. Such exemplary determining operation (S62) according to example embodiments may comprise an operation of minimizing a total number of allocated processing resource units of said plurality of processing resource units.

According to a variation of the procedure shown in FIG. 6, exemplary details of the determining operation (S62) are given, which are inherently independent from each other as such. Such exemplary determining operation (S62) according to example embodiments may comprise an operation of combining, for a predetermined time period, a first sub-set of said selected radio cells such that a total of said predicted future computational load of baseband processing for each first radio cell of said first sub-set of said selected radio cells does not exceed said computation capabilities of a first processing resource unit of said plurality of processing resource units, and an operation of assigning each first radio cell of said first sub-set of said selected radio cells to said first processing resource unit.

According to a variation of the procedure shown in FIG. 6, exemplary details of the determining operation (S62) are given, which are inherently independent from each other as such. Such exemplary determining operation (S62) according to example embodiments may comprise an operation of combining, for said predetermined time period, a second sub-set of said selected radio cells excluding said first radio cells of said first sub-set of said selected radio cells such that a total of said predicted future computational load of baseband processing for each second radio cell of said second sub-set of said selected radio cells does not exceed said computation capabilities of a second processing resource unit of said plurality of processing resource units, and an operation of assigning each second radio cell of said second sub-set of said selected radio cells to said second processing resource unit.

According to a variation of the procedure shown in FIG. 6, exemplary details of the acquiring operation (S61) are given, which are inherently independent from each other as such. Such exemplary acquiring operation (S61) according to example embodiments may comprise an operation of receiving said predicted future computational load of baseband processing for each selected radio cell of a plurality of radio cells.

According to a variation of the procedure shown in FIG. 6, exemplary details of the acquiring operation (S61) are given, which are inherently independent from each other as such. Such exemplary acquiring operation (S61) according to example embodiments may comprise an operation of computing said predicted future computational load of baseband processing for each selected radio cell of said plurality of radio cells based on per-cell monitoring information for each of said selected radio cells of said plurality of radio cells.

According to further example embodiments, said per-cell monitoring information includes at least one of a key performance indicator, a cell throughput, a number of radio resource control connected terminals, a number of active terminals, a number of carrier aggregation users, a number of multi-user multiple input multiple output users, a quality of service class identifier, a guaranteed bit rate, a maximum bit rate, a latency sensitivity of on-going applications, a type of service, a combined weight aggregated for each terminal over all digital radio bearers, a list of key features enabled on said respective cell, a current computational load per slot, a current physical resource blocks usage, a rank of terminals served by said respective cell, a modulation and coding scheme, and a physical uplink control channel utilization.

According to a variation of the procedure shown in FIG. 6, exemplary additional operations are given, which are inherently independent from each other as such. According to such variation, an exemplary method according to example embodiments may comprise an operation of receiving said per-cell monitoring information for each of said selected radio cells of said plurality of radio cells.

According to further example embodiments, said computing utilizes machine learning techniques.

According to further example embodiments, said computing is based on event information.

According to further example embodiments, said computing is based on at least one of a time of day, a day of week, a mean value related to said time of day, and a standard deviation value related to said time of day.

According to a variation of the procedure shown in FIG. 6, exemplary details of the computing operation are given, which are inherently independent from each other as such. Such exemplary computing operation according to example embodiments may comprise an operation of computing said predicted future computational load of baseband processing for each slice of at least one selected radio cell of said plurality of radio cells based on said per-cell monitoring information for each of said selected radio cells of said plurality of radio cells.

According to a variation of the procedure shown in FIG. 6, exemplary additional operations are given, which are inherently independent from each other as such. According to such variation, an exemplary method according to example embodiments may comprise an operation of transmitting information on said allocation of each selected radio cell of said plurality of radio cells to anyone of said plurality of processing resource units towards a base station.

According to further example embodiments, said processing resource unit is at least one of a processor, a processor core, and a memory unit.

According to further example embodiments, said computational load is a number of processor instruction cycles.

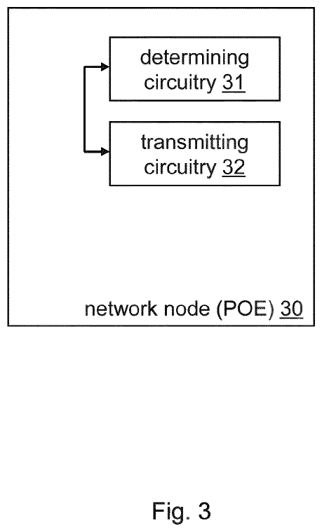

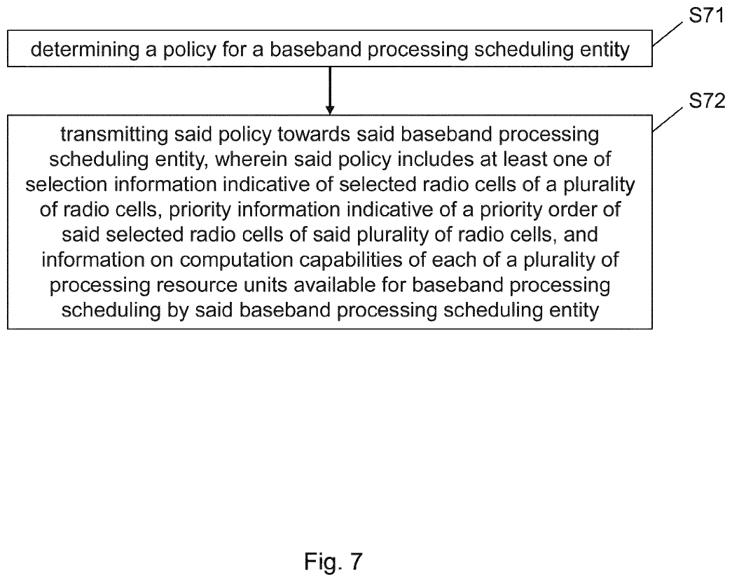

FIG. 3 is a block diagram illustrating an apparatus according to example embodiments. The apparatus may be a network node 30 such as a policy and orchestration engine, the apparatus comprising determining circuitry 31 and transmitting circuitry 32. The determining circuitry 31 determines a policy for a baseband processing scheduling entity. The transmitting circuitry 32 transmits said policy towards said baseband processing scheduling entity. Here, the policy includes at least one of selection information indicative of selected radio cells of a plurality of radio cells, priority information indicative of a priority order of said selected radio cells of said plurality of radio cells, and information on computation capabilities of each of a plurality of processing resource units available for baseband processing scheduling by said baseband processing scheduling entity. FIG. 7 is a schematic diagram of a procedure according to example embodiments. The apparatus according to FIG. 3 may perform the method of FIG. 7 but is not limited to this method. The method of FIG. 7 may be performed by the apparatus of FIG. 3 but is not limited to being performed by this apparatus.

As shown in FIG. 7, a procedure according to example embodiments comprises an operation of determining (S71) a policy for a baseband processing scheduling entity, and an operation of transmitting (S72) said policy towards said baseband processing scheduling entity, wherein said policy includes at least one of selection information indicative of selected radio cells of a plurality of radio cells, priority information indicative of a priority order of said selected radio cells of said plurality of radio cells, and information on computation capabilities of each of a plurality of processing resource units available for baseband processing scheduling by said baseband processing scheduling entity.

In an embodiment at least some of the functionalities of the apparatus shown in FIG. 3 may be shared between two physically separate devices forming one operational entity. Therefore, the apparatus may be seen to depict the operational entity comprising one or more physically separate devices for executing at least some of the described processes.

According to further example embodiments, said priority information includes per-cell priority information for each of said selected radio cells of said plurality of radio cells, and said per-cell priority information includes at least one of a quality of service class identifier, a guaranteed bit rate, a maximum bit rate, a latency sensitivity of on-going applications, a type of service, a rank of terminals served by said respective cell, a modulation and coding scheme, a physical uplink control channel utilization, and a number of past skipped slots.

According to further example embodiments, said policy includes at least one of a baseband processing computational load prediction validity time interval and a baseband processing computational load type.

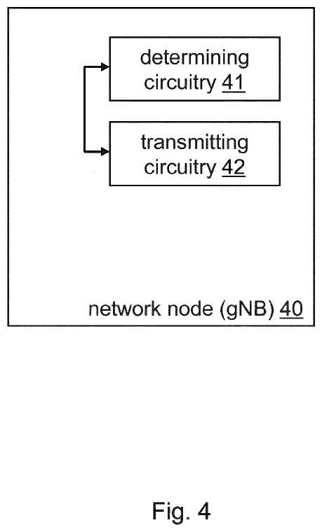

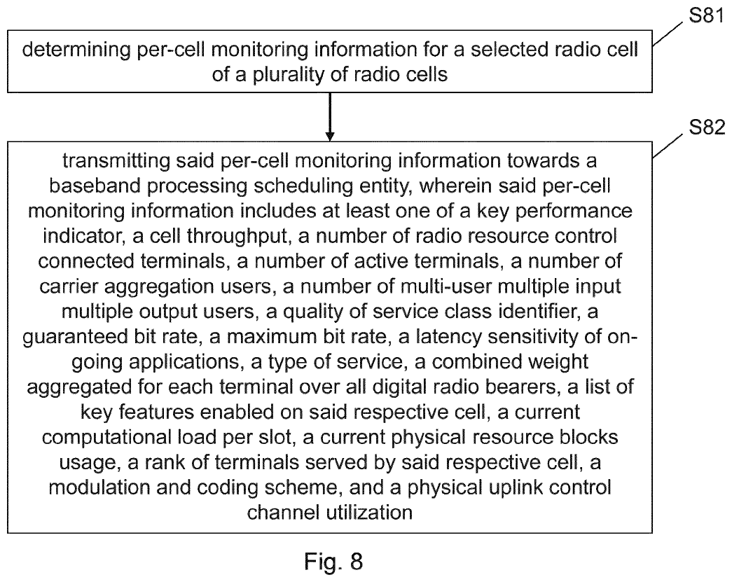

FIG. 4 is a block diagram illustrating an apparatus according to example embodiments. The apparatus may be a network node 40 such as an access node such as a base station, e.g. a gNB, the apparatus comprising determining circuitry 41 and transmitting circuitry 42. The determining circuitry 41 determines per-cell monitoring information for a selected radio cell of a plurality of radio cells. The transmitting circuitry 42 transmits said per-cell monitoring information towards a baseband processing scheduling entity. Here, the per-cell monitoring information includes at least one of a key performance indicator, a cell throughput, a number of radio resource control connected terminals, a number of active terminals, a number of carrier aggregation users, a number of multi-user multiple input multiple output users, a quality of service class identifier, a guaranteed bit rate, a maximum bit rate, a latency sensitivity of on-going applications, a type of service, a combined weight aggregated for each terminal over all digital radio bearers, a list of key features enabled on said respective cell, a current computational load per slot, a current physical resource blocks usage, a rank of terminals served by said respective cell, a modulation and coding scheme, and a physical uplink control channel utilization. FIG. 8 is a schematic diagram of a procedure according to example embodiments. The apparatus according to FIG. 4 may perform the method of FIG. 8 but is not limited to this method. The method of FIG. 8 may be performed by the apparatus of FIG. 4 but is not limited to being performed by this apparatus.

As shown in FIG. 8, a procedure according to example embodiments comprises an operation of determining (S81) per-cell monitoring information for a selected radio cell of a plurality of radio cells, and an operation of transmitting (S82) said per-cell monitoring information towards a baseband processing scheduling entity, wherein said per-cell monitoring information includes at least one of a key performance indicator, a cell throughput, a number of radio resource control connected terminals, a number of active terminals, a number of carrier aggregation users, a number of multi-user multiple input multiple output users, a quality of service class identifier, a guaranteed bit rate, a maximum bit rate, a latency sensitivity of on-going applications, a type of service, a combined weight aggregated for each terminal over all digital radio bearers, a list of key features enabled on said respective cell, a current computational load per slot, a current physical resource blocks usage, a rank of terminals served by said respective cell, a modulation and coding scheme, and a physical uplink control channel utilization.

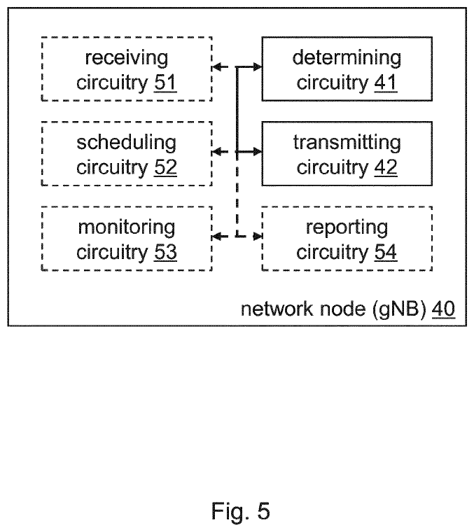

FIG. 5 is a block diagram illustrating an apparatus according to example embodiments. In particular, FIG. 5 illustrates a variation of the apparatus shown in FIG. 4. The apparatus according to FIG. 5 may thus further comprise receiving circuitry 51, scheduling circuitry 52, monitoring circuitry 53, and/or reporting circuitry 54.

In an embodiment at least some of the functionalities of the apparatus shown in FIG. 4 (or 5) may be shared between two physically separate devices forming one operational entity. Therefore, the apparatus may be seen to depict the operational entity comprising one or more physically separate devices for executing at least some of the described processes.

According to a variation of the procedure shown in FIG. 8, exemplary additional operations are given, which are inherently independent from each other as such. According to such variation, an exemplary method according to example embodiments may comprise an operation of receiving, from said baseband processing scheduling entity, information on an allocation of said selected radio cell of said plurality of radio cells to a processing resource unit.

According to a variation of the procedure shown in FIG. 8, exemplary additional operations are given, which are inherently independent from each other as such. According to such variation, an exemplary method according to example embodiments may comprise an operation of scheduling, based on said information on said allocation of said selected radio cell of said plurality of radio cells to said processing resource unit, for a predetermined time period, baseband processing for said selected radio cell of said plurality of radio cells to said processing resource unit.

According to a variation of the procedure shown in FIG. 8, exemplary additional operations are given, which are inherently independent from each other as such. According to such variation, an exemplary method according to example embodiments may comprise an operation of monitoring baseband processing performance, and if, as a result of said monitoring, skipped slots are traced, an operation of reporting a number of said skipped slots towards said baseband processing scheduling entity.

Example embodiments are described below in more specific terms.

According to example embodiments, a CP (module) and the compute estimation/prediction calculation may be implemented as follows.

Based on a request the CPO receives, the CP (sub) module accesses corresponding RAN data and processes the data to calculate the estimated/predicted compute load.

Compute load estimation/prediction is a time series prediction/estimation problem, where based on the past time samples of the cell load and also additional features for example event information (e.g., cell compute load could be high during an upcoming concert in region covered by the cell), in the cell of interest and also neighboring cells, cell compute load is predicted/estimated.

Here, according to example embodiments, the CP (module) uses machine learning (ML)/deep learning (DL) model(s) and uses RAN data as input to predict/estimate compute load by calculation.

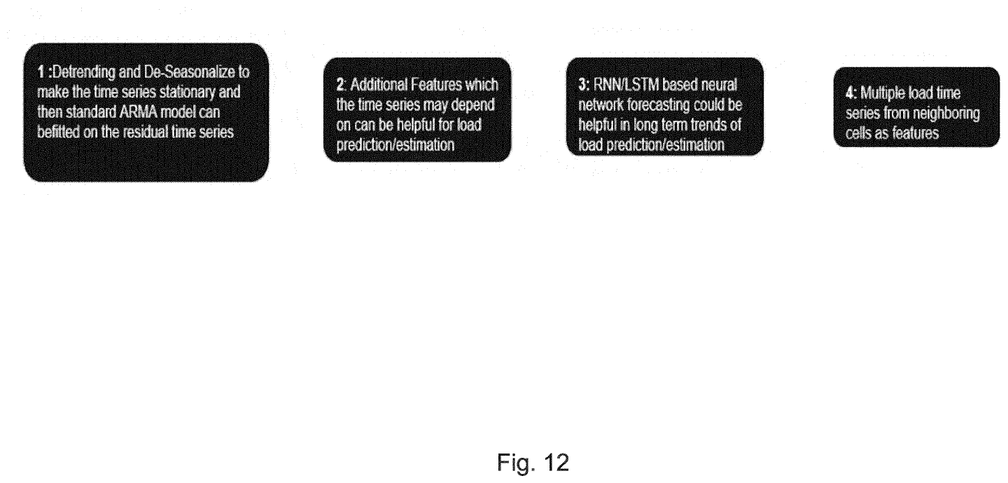

FIG. 12 illustrates examples of prediction measures of an apparatus according to example embodiments.

According to example embodiments, the CP (module) may contain all or a combination of the four time series prediction/estimation model building blocks illustrated in FIG. 12.

Namely, the foreseen time series prediction/estimation model building blocks are
de-trending and de-seasonalizing to make the time series stationary and then, standard autoregressive moving average (ARMA) model can be fitted on the residual time series (“1”),
additional features which the time series may depend on can be helpful for load prediction estimation (“2”),
recurrent neural network (RNN)/long short term memory (LSTM) based neural network forecasting could be helpful in long term trends of load prediction/estimation (“3”), and
multiple load time series from neighboring cells as features (“4”).

According to example embodiments, the CP (module) may specify the neighbor cell relations (see “4”) whose load time series can be used for load prediction/estimation for a cell of interest, based on the ML/DL model used.

According to example embodiments, as the load (time series) prediction/estimation model depends largely on the data, for example for load with apparent trend, very simple load prediction model using de-trending approaches might work well (see “1”), however, for load with difficult to predict spikes/dips, a more complicated load prediction model using e.g. LSTM may be required (see “3”).

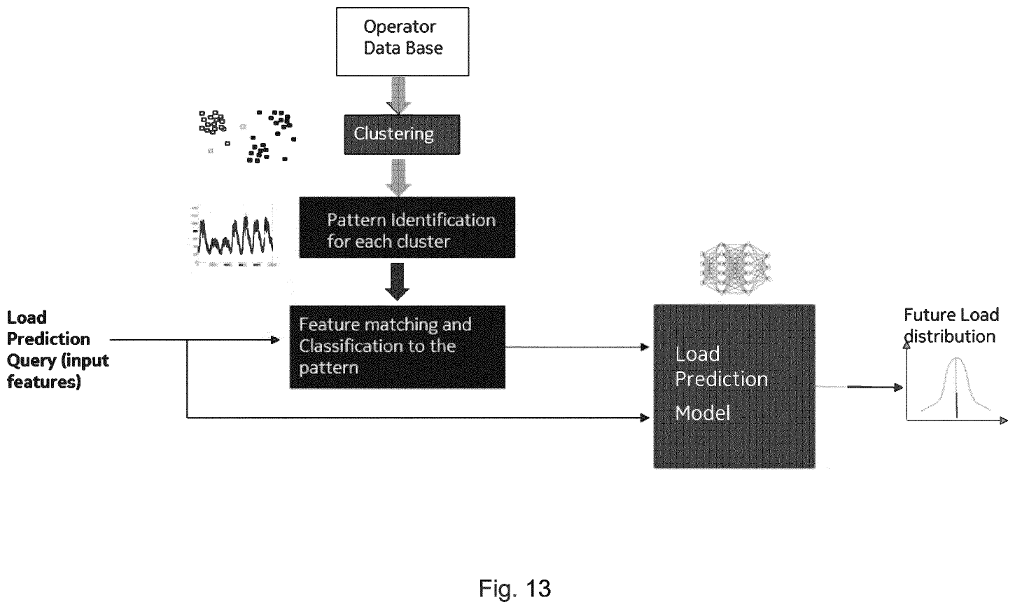

FIG. 13 illustrates an example of a prediction behavior of an apparatus according to example embodiments, and in particular shows a general CP pipeline according to example embodiments.

According to example embodiments, a CP (module) using neural networks may be implemented as follows.

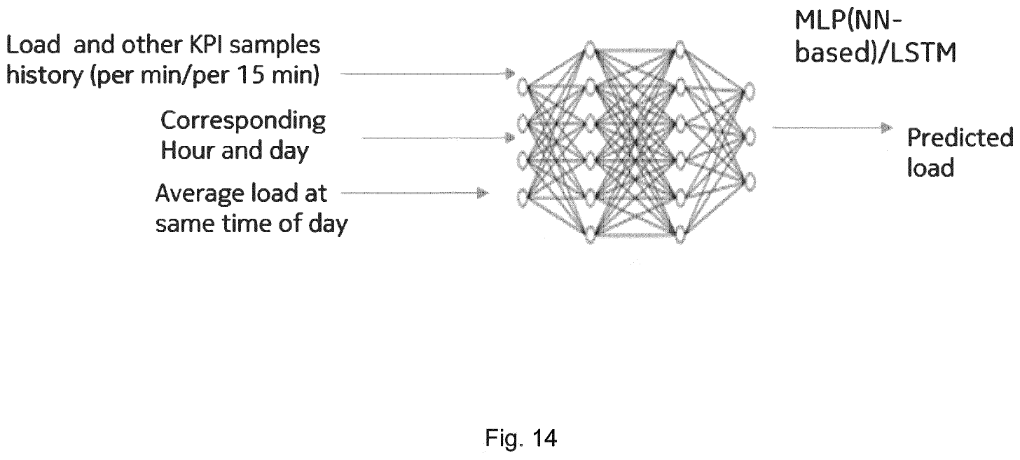

FIG. 14 illustrates an example of a neural network with example inputs and outputs according to example embodiments.

Given the challenging cell load time series observed on the field (with dynamic peaks and valleys), a neural network based function estimator forms a natural solution choice for load prediction.

According to example embodiments, sufficiently deep neural network architectures combined with a stochastic gradient descent algorithm, known to be very efficient predictors, are applied.

In addition to load and KPI history of the cell, according to example embodiments, features such as the following are used to predict the compute load in the prediction interval
time of day, day of week, any special event (e.g., holidays),
mean compute at that time of day, and
standard deviation/other moments of compute at that time of day etc.

According to example embodiments, a CP (module) in CPO may be further implemented as follows.

Based on the different prediction/estimate time length for which load estimate should be valid and also timescale, CP may use a different ML/DL model, as some models have a better autoregressive prediction characteristic than others. In addition, data characteristics at large time scale may not be similar compared to a more granular timescale and different would be models needed. CP modules according to example embodiments may thus consider these alternatives and their respective suitability.

According to example embodiments, prediction/estimation of (computational) load may use a different ML/DL model. For example, a multilayer perceptron (MLP) neural network may be applied for estimation, and LSTM may be applied for load prediction.

According to example embodiments, the models for compute prediction in the CP are continuously updated based on the data from the RAN.

According to example embodiments, with respect to a service discovery API, in principle, there might be different instances of CP, e.g., each handling different groups of cells.

According to example embodiments, with respect to an extension to slicing, the CP module does not just provide load prediction/estimate at cell level but could also be used at slice level across a single or multiple cells.

According to example embodiments, a CS (module) and an algorithm thereof may be implemented as follows.

Namely, according to example embodiments, the output from the CP may be the amount of CPU cycles (as an example measure for the computational load) required for the BB processing of each cell. This information is used by the CS according to example embodiments in addition to the weights discussed below to map the cells to cores.

In detail, according to example embodiments, scheduling weights (per-Cell) are determined based on various aspects like (including but not limited to) QCI, GBR/MBR, latency sensitivity of on-going apps, type of service, rank of UEs, MCS, PUCCH utilization, number of past skipped slots.

Each of these factors carries weights, e.g. w1, w2, w3, w4, w5 and w6, respectively, which contribute to the overall cell priority.

Further, according to example embodiments, the CS calculates the overall cell priority or scheduling weights based on w1, w2, . . . , etc., and uses the cell priority to schedule compute resources for different cells based on the requirements received from CP.

Further, an example algorithm for assigning compute resources by the CS according to example embodiments includes assigning required resources for each cell in decreasing order of priority starting from the highest priority cell (based on scheduler weight). However, other more sophisticated algorithms like proportional fairness algorithm, etc., may be used as well.

Further, according to example embodiments, mapping of cells to cores, as illustrated as output from the CS in FIG. 11 is downloaded towards a gNB (being an example of a network node being e.g. a base station) over e.g. a standard E2 interface at regular intervals and also on-demand.

Further, according to example embodiments, a resource allocator (L1 and L2 real-time instances) on the gNB is responsible for assigning the cells to cores for baseband processing as per the ‘cells-to-cores’ mapping details received from the CPO, i.e., downloaded towards the gNB.

Further, according to example embodiments, L1 and L2 real-time processing on gNB monitors the performance after the cells to cores assignments. According to example embodiments, L1 and L2 real-time processing on gNB reports to RIC on the following:
a number of skipped slots (as the processor/core could not finish processing within the slot duration); meanwhile, L1 and L2 real-time processing on gNB may start to force some limitations on capacity; e.g., a number of UEs for TD processing may be reduced from 50 to 20 UEs to save on CPU cycles, and
keep reporting parameters (as illustrated in FIG. 11) that are used for machine learning.

The overall intent here, and the effect achieved by the above measures according to example embodiments, is to make sure that the cores are not running idle but to near-capacity and at the same there is no impact on overall performance.

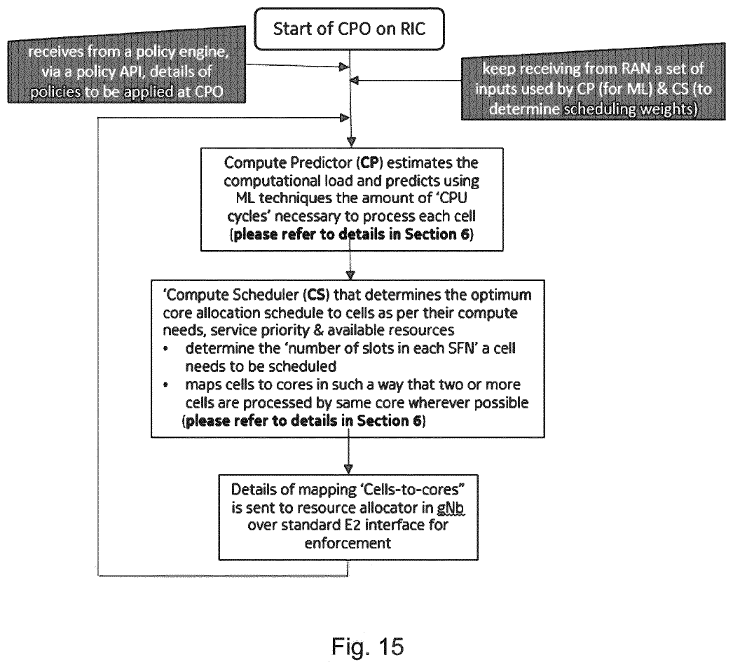

FIG. 15 is a schematic diagram of a procedure according to example embodiments, and in particular provides a summarizing overview of overall processing in CPO.

As is illustrated in FIG. 15, after start of CPO on RIC, details of policies to be applied at CPO are received from a policy engine via a policy API, and a set of inputs used by CP (for ML) and CS (to determine scheduling weights) is constantly received from a gNB.

Further, the CP estimates/predicts the computational load/the amount of CPU cycles necessary to process each cell using ML techniques.

Further, the CS determines the optimum core allocation schedule to cells as per their compute needs, service priority, and available resources. Heretofore, the CS determines the number of slots in each SFN a cell needs to be scheduled, and maps cells to cores in such a way that two or more cells are processed by same core wherever possible.

Further, details of mapping ‘cells-to-cores’ are sent to gNB over e.g. the standard E2 interface for enforcement (by (a resource allocator of) the gNB).

The above-described procedures and functions may be implemented by respective functional elements, processors, or the like, as described below.

In the foregoing exemplary description of the network entity, only the units that are relevant for understanding the principles of the disclosure have been described using functional blocks. The network entity may comprise further units that are necessary for its respective operation. However, a description of these units is omitted in this specification. The arrangement of the functional blocks of the devices is not construed to limit the disclosure, and the functions may be performed by one block or further split into sub-blocks.

When in the foregoing description it is stated that the apparatus, i.e. network entity or network node (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “unit configured to” is construed to be equivalent to an expression such as “means for”).

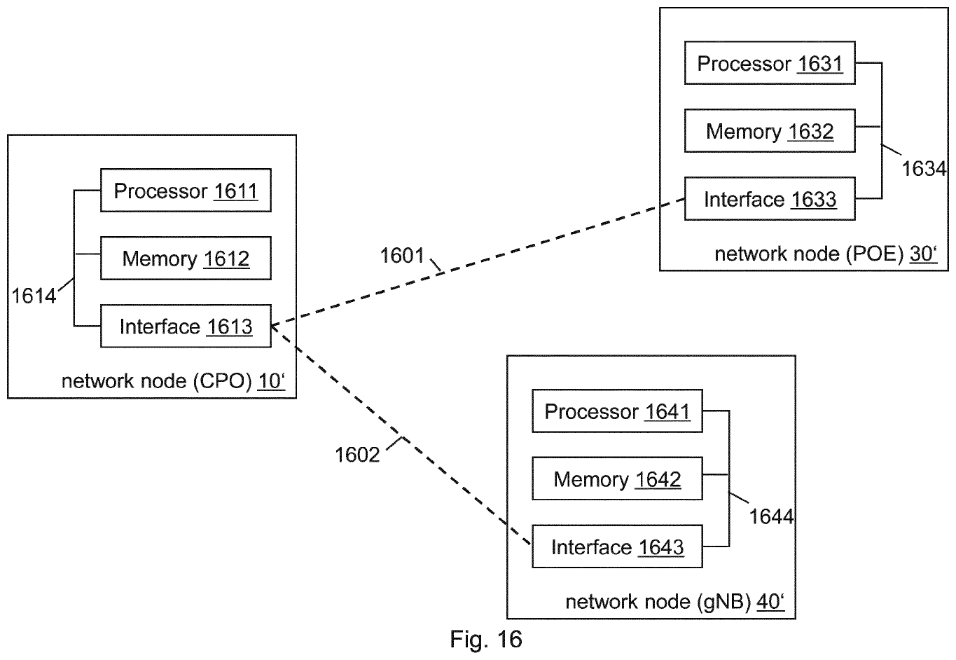

In FIG. 16, an alternative illustration of apparatuses according to example embodiments is depicted. As indicated in FIG. 16, according to example embodiments, the apparatus (network node) 10′ (corresponding to the network node 10) comprises a processor 1611, a memory 1612 and an interface 1613, which are connected by a bus 1614 or the like. Further, according to example embodiments, the apparatus (network node) 30′ (corresponding to the network node 30) comprises a processor 1631, a memory 1632 and an interface 1633, which are connected by a bus 1634 or the like. Further, according to example embodiments, the apparatus (network node) 40′ (corresponding to the network node 40) comprises a processor 1641, a memory 1642 and an interface 1643, which are connected by a bus 1644 or the like. The apparatuses may be connected via links 1601 and 1602, respectively.

The processor 1611/1631/1641 and/or the interface 1613/1633/1643 may also include a modem or the like to facilitate communication over a (hardwire or wireless) link, respectively. The interface 1613/1633/1643 may include a suitable transceiver coupled to one or more antennas or communication means for (hardwire or wireless) communications with the linked or connected device(s), respectively. The interface 1613/1633/1643 is generally configured to communicate with at least one other apparatus, i.e. the interface thereof.

The memory 1612/1632/1642 may store respective programs assumed to include program instructions or computer program code that, when executed by the respective processor, enables the respective electronic device or apparatus to operate in accordance with the example embodiments.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e. the expression “processor configured to [cause the apparatus to] perform xxx-ing” is construed to be equivalent to an expression such as “means for xxx-ing”).

According to example embodiments, an apparatus representing the network node 10 comprises at least one processor 1611, at least one memory 1612 including computer program code, and at least one interface 1613 configured for communication with at least another apparatus. The processor (i.e. the at least one processor 1611, with the at least one memory 1612 and the computer program code) is configured to perform acquiring a predicted future computational load of baseband processing for each selected radio cell of a plurality of radio cells (thus the apparatus comprising corresponding means for acquiring), and to perform determining an allocation of each selected radio cell of said plurality of radio cells to anyone of a plurality of processing resource units based on said predicted future computational load of baseband processing for each selected radio cell of said plurality of radio cells and computation capabilities of each of said plurality of processing resource units (thus the apparatus comprising corresponding means for determining).

According to example embodiments, an apparatus representing the network node 30 comprises at least one processor 1631, at least one memory 1632 including computer program code, and at least one interface 1633 configured for communication with at least another apparatus. The processor (i.e. the at least one processor 1631, with the at least one memory 1632 and the computer program code) is configured to perform determining a policy for a baseband processing scheduling entity (thus the apparatus comprising corresponding means for determining), and to perform transmitting said policy towards said baseband processing scheduling entity, wherein said policy includes at least one of selection information indicative of selected radio cells of a plurality of radio cells, priority information indicative of a priority order of said selected radio cells of said plurality of radio cells, and information on computation capabilities of each of a plurality of processing resource units available for baseband processing scheduling by said baseband processing scheduling entity (thus the apparatus comprising corresponding means for transmitting).

According to example embodiments, an apparatus representing the network node 40 comprises at least one processor 1641, at least one memory 1642 including computer program code, and at least one interface 1643 configured for communication with at least another apparatus. The processor (i.e. the at least one processor 1641, with the at least one memory 1642 and the computer program code) is configured to perform determining per-cell monitoring information for a selected radio cell of a plurality of radio cells (thus the apparatus comprising corresponding means for determining), and to perform transmitting said per-cell monitoring information towards a baseband processing scheduling entity, wherein said per-cell monitoring information includes at least one of a key performance indicator, a cell throughput, a number of radio resource control connected terminals, a number of active terminals, a number of carrier aggregation users, a number of multi-user multiple input multiple output users, a quality of service class identifier, a guaranteed bit rate, a maximum bit rate, a latency sensitivity of on-going applications, a type of service, a combined weight aggregated for each terminal over all digital radio bearers, a list of key features enabled on said respective cell, a current computational load per slot, a current physical resource blocks usage, a rank of terminals served by said respective cell, a modulation and coding scheme, and a physical uplink control channel utilization (thus the apparatus comprising corresponding means for transmitting).

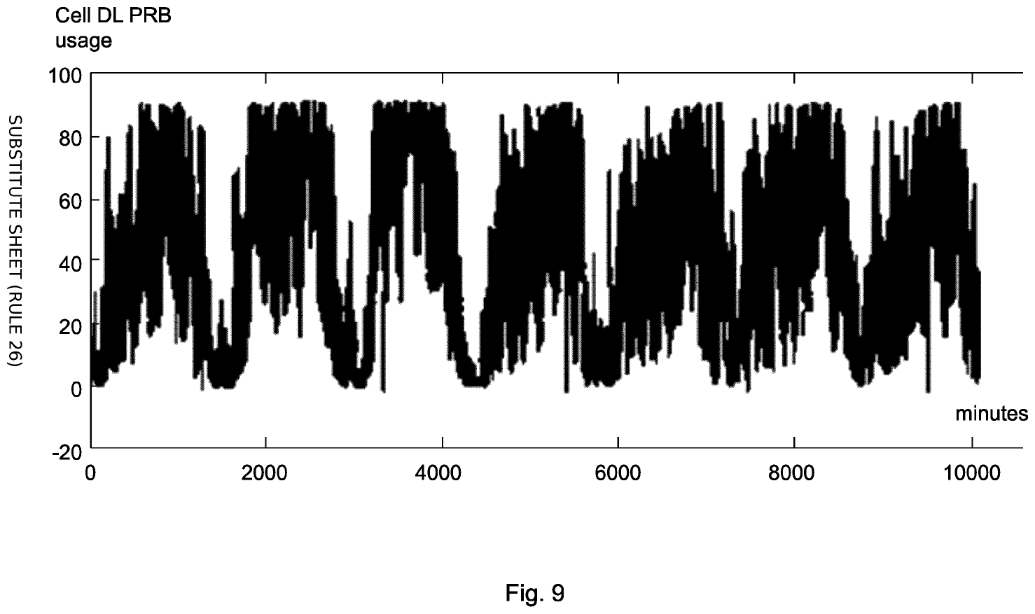

For further details regarding the operability/functionality of the individual apparatuses, reference is made to the above description in connection with any one of FIGS. 1 to 15, respectively.

For the purpose of the present disclosure as described herein above, it should be noted that
method steps likely to be implemented as software code portions and being run using a processor at a network server or network entity (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined network entity or network register, or any one of their respective units/means) can be implemented as individual devices, units or means, but this does not exclude that they are implemented in a distributed fashion throughout the system, as long as the functionality of the device, unit or means is preserved;
an apparatus like the user equipment and the network entity/network register may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present disclosure. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present disclosure also covers any conceivable combination of method steps and operations described above, and any conceivable combination of nodes, apparatuses, modules or elements described above, as long as the above-described concepts of methodology and structural arrangement are applicable.

In view of the above, there are provided measures for efficient cell baseband processing pooling. Such measures exemplarily comprise acquiring a predicted future computational load of baseband processing for each selected radio cell of a plurality of radio cells, and determining an allocation of each selected radio cell of said plurality of radio cells to anyone of a plurality of processing resource units based on said predicted future computational load of baseband processing for each selected radio cell of said plurality of radio cells and computation capabilities of each of said plurality of processing resource units.

Even though the disclosure is described above with reference to the examples according to the accompanying drawings, it is to be understood that the disclosure is not restricted thereto. Rather, it is apparent to those skilled in the art that the present disclosure can be modified in many ways without departing from the scope of the inventive idea as disclosed herein.

### LIST OF ACRONYMS AND ABBREVIATIONS

3GPP Third Generation Partnership Project
API application programming interface
ARMA autoregressive moving average
BB baseband
CA carrier aggregation
CPO Compute Predictor and Orchestrator
CP Compute Predictor
CPU central processing unit
CS Compute Scheduler
DL deep learning
DL downlink
FD frequency division
FD frequency domain
GBR guaranteed bitrate
gNB Global Node B (base station)
L1 layer-1
L2 layer-2
L2-PS layer-2 packet scheduler
LSTM long short term memory
MANO management and orchestration
MBR maximum bitrate
MCS modulation coding scheme
ML machine learning
MLP multilayer perceptron
MU-MIMO multi-user multiple input multiple output
NFV network function virtualization
OPEX operational expenditure
oRAN open radio access network
PRB physical resource blocks
PUCCH physical uplink control channel
QCI quality of service class identifier
QoS quality of service
RAN radio access network
RIC radio intelligent controller
RNN recurrent neural network
RRC radio resource control
RRM radio resource management
RT real-time
SFN sub frame number
SFN system frame number
TD time division
TD time domain
TDD time division duplex
UE user equipment
VIM virtualized infrastructure manager

1. A method comprising
acquiring a predicted future computational load of baseband processing for each selected radio cell of a plurality of radio cells,
determining an allocation of each selected radio cell of said plurality of radio cells to anyone of a plurality of processing resource units based on said predicted future computational load of baseband processing for each selected radio cell of said plurality of radio cells and computation capabilities of each of said plurality of processing resource units, and
transmitting information on said allocation of each selected radio cell of said plurality of radio cells to anyone of said plurality of processing resource units towards a base station.

2. (canceled)

3. The method according to claim 1, further comprising
receiving priority information indicative of a priority order of said selected radio cells of said plurality of radio cells, wherein
said determining is based on said priority order of said selected radio cells of said plurality of radio cells.

4. The method according to claim 3, wherein
said priority information includes per-cell priority information for each of said selected radio cells of said plurality of radio cells, and
said method further comprises
calculating, for each respective of said selected radio cells of said plurality of radio cells, a respective cell priority based on said respective per-cell priority information for said respective of said selected radio cells of said plurality of radio cells.

5. The method according to claim 4, wherein
said per-cell priority information includes at least one of a quality of service class identifier, a guaranteed bit rate, a maximum bit rate, a latency sensitivity of on-going applications, a type of service, a rank of terminals served by said respective cell, a modulation and coding scheme, a physical uplink control channel utilization, and a number of past skipped slots.

6. (canceled)

7. The method according to claim 5, wherein
in relation to said determining, the method further comprises
minimizing a total number of allocated processing resource units of said plurality of processing resource units.

8. The method according to claim 7, wherein
in relation to said determining, the method further comprises
combining, for a predetermined time period, a first sub-set of said selected radio cells such that a total of said predicted future computational load of baseband processing for each first radio cell of said first sub-set of said selected radio cells does not exceed said computation capabilities of a first processing resource unit of said plurality of processing resource units, and
assigning each first radio cell of said first sub-set of said selected radio cells to said first processing resource unit.

9. The method according to claim 8, wherein
in relation to said determining, the method further comprises
combining, for said predetermined time period, a second sub-set of said selected radio cells excluding said first radio cells of said first sub-set of said selected radio cells such that a total of said predicted future computational load of baseband processing for each second radio cell of said second sub-set of said selected radio cells does not exceed said computation capabilities of a second processing resource unit of said plurality of processing resource units, and
assigning each second radio cell of said second sub-set of said selected radio cells to said second processing resource unit.

10. The method according to claim 9, wherein
in relation to said acquiring, the method further comprises
receiving said predicted future computational load of baseband processing for each selected radio cell of a plurality of radio cells, and
computing said predicted future computational load of baseband processing for each selected radio cell of said plurality of radio cells based on per-cell monitoring information for each of said selected radio cells of said plurality of radio cells.

11. (canceled)

12. The method according to claim 10, wherein
said per-cell monitoring information includes at least one of a key performance indicator, a cell throughput, a number of radio resource control connected terminals, a number of active terminals, a number of carrier aggregation users, a number of multi-user multiple input multiple output users, a quality of service class identifier, a guaranteed bit rate, a maximum bit rate, a latency sensitivity of on-going applications, a type of service, a combined weight aggregated for each terminal over all digital radio bearers, a list of key features enabled on said respective cell, a current computational load per slot, a current physical resource blocks usage, a rank of terminals served by said respective cell, a modulation and coding scheme, and a physical uplink control channel utilization.

13-15. (canceled)

16. The method according to claim 10, wherein
said computing is based on at least one of a time of day, a day of week, a mean value related to said time of day, and a standard deviation value related to said time of day.

17. The method according to claim 16, wherein
in relation to said computing, the method further comprises
computing said predicted future computational load of baseband processing for each slice of at least one selected radio cell of said plurality of radio cells based on said per-cell monitoring information for each of said selected radio cells of said plurality of radio cells.

18-27. (canceled)

28. An apparatus comprising
acquiring circuitry configured to acquire a predicted future computational load of baseband processing for each selected radio cell of a plurality of radio cells, and
determining circuitry configured to determine an allocation of each selected radio cell of said plurality of radio cells to anyone of a plurality of processing resource units based on said predicted future computational load of baseband processing for each selected radio cell of said plurality of radio cells and computation capabilities of each of said plurality of processing resource units.

29. (canceled)

30. The apparatus according to claim 28, further comprising
receiving circuitry configured to receive priority information indicative of a priority order of said selected radio cells of said plurality of radio cells, wherein
said determining circuitry is configured to determine based on said priority order of said selected radio cells of said plurality of radio cells.

31. The apparatus according to claim 30, wherein
said priority information includes per-cell priority information for each of said selected radio cells of said plurality of radio cells, and
said apparatus further comprises
calculating circuitry configured to calculate, for each respective of said selected radio cells of said plurality of radio cells, a respective cell priority based on said respective per-cell priority information for said respective of said selected radio cells of said plurality of radio cells.

32. The apparatus according to claim 31, wherein
said per-cell priority information includes at least one of a quality of service class identifier, a guaranteed bit rate, a maximum bit rate, a latency sensitivity of on-going applications, a type of service, a rank of terminals served by said respective cell, a modulation and coding scheme, a physical uplink control channel utilization, and a number of past skipped slots.

33. (canceled)

34. The apparatus according to claim 28, further comprising
minimizing circuitry configured to minimize a total number of allocated processing resource units of said plurality of processing resource units.

35. The apparatus according to claim 28, further comprising
combining circuitry configured to combine, for a predetermined time period, a first sub-set of said selected radio cells such that a total of said predicted future computational load of baseband processing for each first radio cell of said first sub-set of said selected radio cells does not exceed said computation capabilities of a first processing resource unit of said plurality of processing resource units, and
assigning circuitry configured to assign each first radio cell of said first sub-set of said selected radio cells to said first processing resource unit.

36. The apparatus according to claim 35, further comprising
combining circuitry configured to combine, for said predetermined time period, a second sub-set of said selected radio cells excluding said first radio cells of said first sub-set of said selected radio cells such that a total of said predicted future computational load of baseband processing for each second radio cell of said second sub-set of said selected radio cells does not exceed said computation capabilities of a second processing resource unit of said plurality of processing resource units, and
assigning circuitry configured to assign each second radio cell of said second sub-set of said selected radio cells to said second processing resource unit.

37-81. (canceled)

82. A computer program product comprising computer-executable computer program code which, when the program is run on a computer, is configured to cause the computer to
acquire a predicted future computational load of baseband processing for each selected radio cell of a plurality of radio cells,
determine an allocation of each selected radio cell of said plurality of radio cells to anyone of a plurality of processing resource units based on said predicted future computational load of baseband processing for each selected radio cell of said plurality of radio cells and computation capabilities of each of said plurality of processing resource units, and
transmit information on said allocation of each selected radio cell of said plurality of radio cells to anyone of said plurality of processing resource units towards a base station.

83. The computer program product according to claim 82, wherein the computer program product comprises a computer-readable medium on which the computer-executable computer program code is stored, and/or wherein the program is directly loadable into an internal memory of the computer or a processor thereof.
